(19) United States
(12) Patent Application Publication
(10) Pub. No.: US 2008/0101972 A1
(43) Pub. Date: May 1, 2008

(54) Single-Way Valve For Scroll Compressor

(76) Inventors: Guang-Der Tarng, Sijhih City (TW); Wen-Yen Wang, Sijhih City (TW); Hsun-An Li, Sijhih City (TW)

Correspondence Address: HDSL, 4331 STEVENS BATTLE LANE, FAIRFAX, VA, 22033, US

(21) Appl. No.: 11/553,994

(22) Filed: Oct. 27, 2006

(51) Int. Cl. F01C 1/02; F01C 1/063; F03C 2/00

(52) U.S. Cl. 418/55.1; 418/55.6

(57) ABSTRACT

A single-way valve is used for scroll compressor. The single-way valve includes a stage, a valve disc and a baffle plate. The stage includes a panel and a guiding post connected to the panel, where a plurality of apertures is defined on the panel. The valve disc includes a through hole capped on the guiding post such that the valve disc has linear movement along the guiding post, The baffle plate is fixed on the guiding post to limit a moving stroke of the valve disc and includes gas runner. The contact area between the baffle plate and the valve disc is below 70% area of the valve disc. The valve disc can fall fast to seal the apertures of the stage to prevent pressured gas from flowing into pressured chamber of the scroll compressor. Noise caused by reverse running of scroll can also be prevented.

### BACKGROUND OF THE INVENTION

1. Field of the Invention

The present invention relates to a single-way valve, especially relates to a single-way valve arranged in the discharge passageway of scroll compressor.

2. Description of Prior Art

Scroll compressor contains compression and transmission elements therein, and friction often occurs among those elements. Therefore, lubricating oil is added in the compressor to provide lubrication and hermetic effect. Moreover, backflow of pressured gas into the pressured chamber might occur when the scroll compressor is stopped. Noise will be generated due to the backflow. Therefore, single-way valve is used to overcome above problem and becomes development issue for the scroll compressor.

U.S. Pat. No. 5,800,141 discloses a discharge valve assembly for scroll compressor. The scroll compressor comprises a discharge passageway and a single-way valve. The single-way valve comprises a stage, a valve disc and a baffle. The stage comprises a thread hole and a plurality of apertures. The baffle comprises a plate and projecting shaft and thread rod extended from the plate, where the thread rod has threaded connection with the thread hole and the projecting shaft passes the center of the plate. The valve disc is placed between the stage and the plate and corresponding to the apertures of the stage for sealing the apertures. Therefore, the valve disc can be used to block backflow gas.

However, the prior art single-way valve has following problems. The valve disc has large contact area with bottom face of the plate. The attaching force therebetween is weak due to cohesion force of oil film. The apertures may be blocked. Moreover, the outer diameter of the valve disc is larger than that of the plate. The valve disk has warps on periphery thereof and cannot completely seal the apertures and high-pressured gas will inject to the scroll member. Moreover, the apertures are defined at peripheral of the stage. The backflow gas will first flow through the apertures and then the valve disc is driven toward the apertures. The valve disc has a lagged response to the backflow gas.

### SUMMARY OF THE INVENTION

The present invention is to provide a single-way valve for scroll compressor, where gas flows through gas runner of a baffle plate and a valve disc falls fast on apertures of stage to prevent pressured gas from flowing into pressured chamber of the scroll compressor.

Accordingly, the present invention provides a single-way valve for scroll compressor. The scroll compressor comprises a discharge passageway and the single-way valve is arranged at one side of the discharge passageway. The single-way valve comprises a stage, a valve disc and a baffle plate. The stage comprises a panel and a guiding post connected to the panel, where a plurality of apertures is defined on the panel. The valve disc comprises a through hole capped on the guiding post such that the valve disc has linear movement along the guiding post, The baffle plate is fixed on the guiding post to limit a moving stroke of the valve disc and comprises gas runner. The contact area between the baffle plate and the valve disc is below 70% area of the valve disc.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a section view of the present invention.

FIG. 2 is a partially enlarged view of part A in FIG. 1.

FIG. 3 is a top view of the baffle plate according to a preferred embodiment of the present invention.

FIG. 4 shows the operation for FIG. 2.

FIG. 5 is a top view of the baffle plate according to another preferred embodiment of the present invention.

FIG. 6 is a top view of the baffle plate according to still another preferred embodiment of the present invention.

FIG. 7 shows a section view of still another preferred embodiment of the present invention.

### DETAILED DESCRIPTION OF THE INVENTION

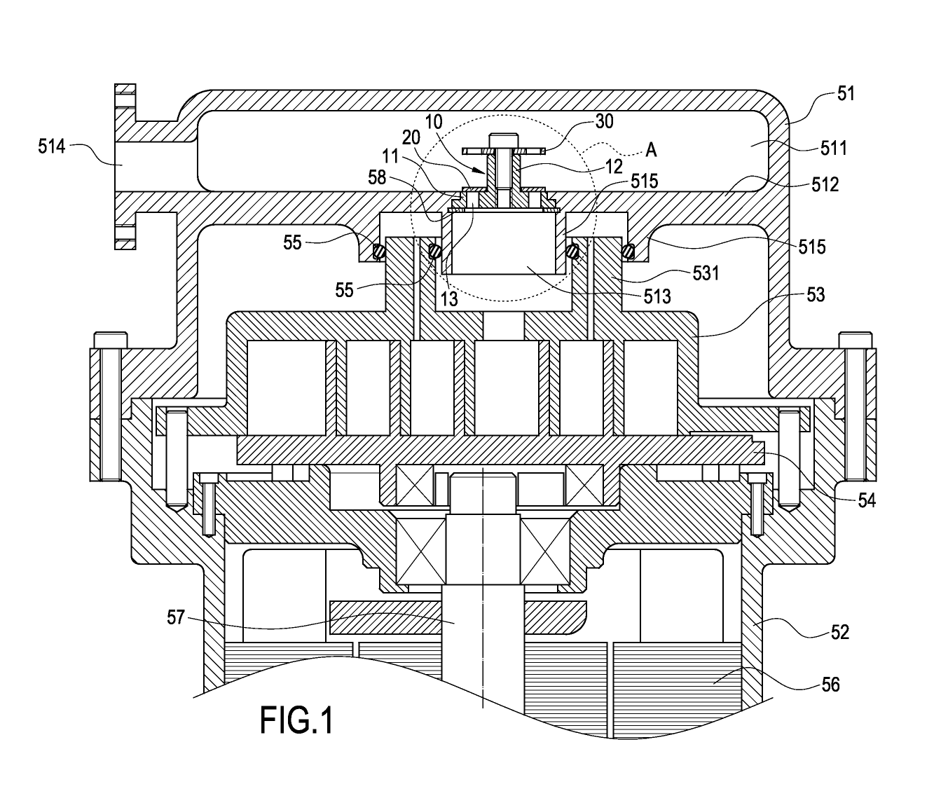

With reference to FIGS. 1 to 4, the present invention provides a single-way valve for a scroll compressor. The scroll compressor 5 comprises an upper shell 51 and a lower shell 52 connected to bottom of the upper shell 51. A discharge passageway 511 is defined in the upper shell 51. The discharge passageway 511 comprises a gas inlet 513 at center of the separation plate 512 and a gas outlet 514 defined on peripheral of the upper shell 51. The lower shell 52 comprises a gas entrance (not shown). A hollow chamber is defined in the upper shell 51 and the lower shell 52. A non-orbiting scroll 53 and an orbiting scroll 54 are arranged in the hollow chamber and are meshed to each other. A plurality of annulus rings 515 and 531 are provided on top of the non-orbiting scroll 53 and the bottom of the separation plate 512. A sealing member is attached to the annulus rings 515 and 531 for providing hermetic effect. Motor 56, transmission member and other compressor member are provided below the orbiting scroll 54. A transmission shaft 57 is extended from the motor 56 and connected to bottom of the orbiting scroll 54 for rotating the orbiting scroll 54.

In the shown preferred embodiment, the single-way valve is arranged in the gas inlet 513 of the discharge passageway 511. The single-way valve mainly comprises a stage 10, a valve disc 20 and a baffle plate 30. The stage 10 comprises a rounded stair-shaped panel 11 and a round guiding post 12 extended upward from the panel 11. Moreover, the panel 11 and the guiding post 12 can be manufactured separately and then assembled. A plurality of apertures 13 is defined on the panel 11 and is in symmetric ring arrangement. The valve disc 20 is of round shape and has a through hole 21 defined at center thereof. The valve disc 20 is fit on the guiding post 12 and has linear movement with the guiding post 12.

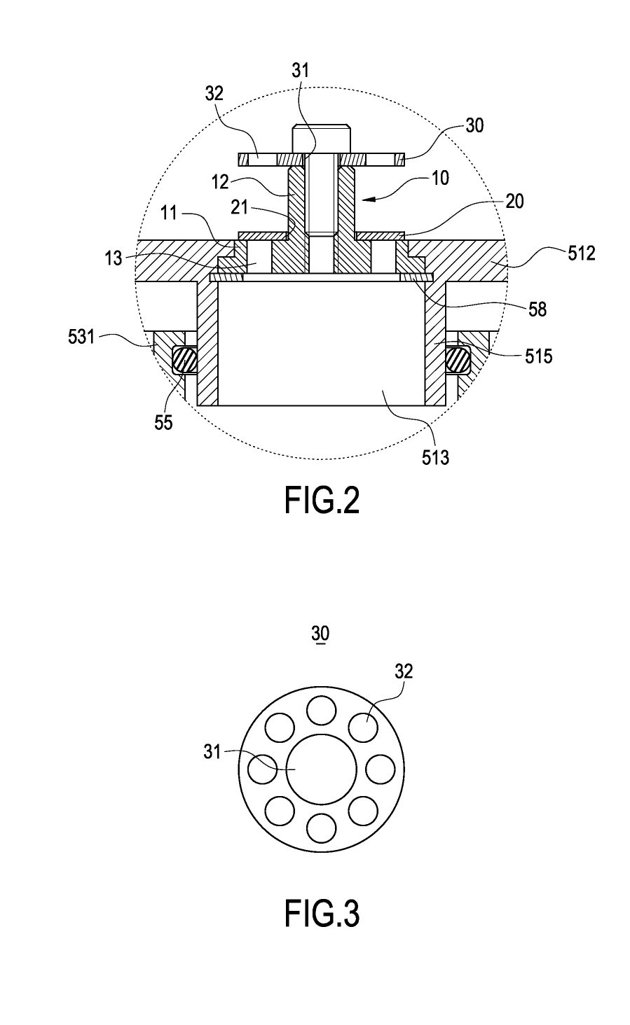

As shown in FIG. 3, the baffle plate 30 is also of round shape and has a fixing hole 31 defined at center thereof, whereby the baffle plate 30 is fixed atop the guiding post 12 by fixing member such as screw. The upward movement of the valve disc 20 is limited by the baffle plate 30. The baffle plate 30 is provided with a plurality of gas runners 32 in annulus arrangement such that the contact area between the baffle plate 30 and the valve disc 20 is below 70% area of the valve disc 20. When the contact area between the baffle plate 30 and the valve disc 20 is more than 71% area of the valve disc 20, the baffle plate 30 and the valve disc 20 are stuck to each other due to the oil therebetween in operation. The valve disc 20 is hard to fall down to seal the apertures 13 in stall condition. Noise will be generated due to reverse operation of the orbiting scroll 54.

In assembling, the valve disc 20 is capped to the guiding post 12 of the stage 10, and then the baffle plate 30 is attached to the top of the guiding post 12. Screws are tightened to the guiding post 12 through the fixing hole 31 to form the single-way valve. The thus-formed single-way valve is arranged in the gas inlet 513 of the discharge passageway 511 and is locked to recess of the annulus rings 515 by a locking ring 58 to finish the assembling of the single-way valve and the scroll compressor 5.

During operation, gas is sucked through the gas entrance below the lower shell 52 and the orbiting scroll 54 is driven by the transmission shaft 57. Gas is sucked by the scrolls 53 and 54 and compressed into pressured gas. The pressured gas pushes the valve disc 20 from the gas inlet 513 of the upper shell 51 and then enters the discharge passageway 511. The pressured gas then discharges through the gas outlet 514 to form a complete compression cycle for the scroll compressor 5. When the scroll compressor 5 is stopped, the pressured gas flows through the gas runners 32 of the baffle plate 30 and the valve disc 20 fast drops to seal the apertures 13 when the scroll compressor 5 is stopped. Therefore, pressured gas can be prevented from flowing into the pressured chamber of the scrolls 53 and 54, which is a reason causing noise of scroll 54.

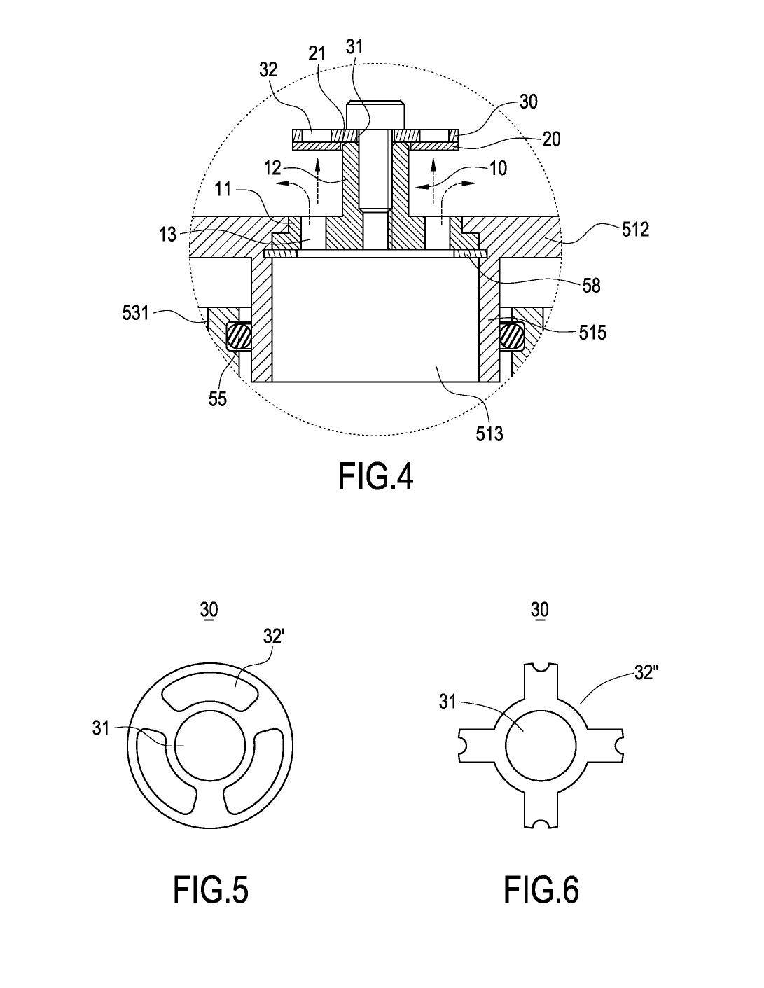

FIGS. 5 and 6 show the baffle plates 30 according to another and still another preferred embodiments of the present invention. The gas runner 32′ in FIG. 5 is of fan-shape. The baffle plate 30 in FIG. 6 is of cross shape and each gas runner 32″ is defined by two adjacent branches of the baffle plate 30.

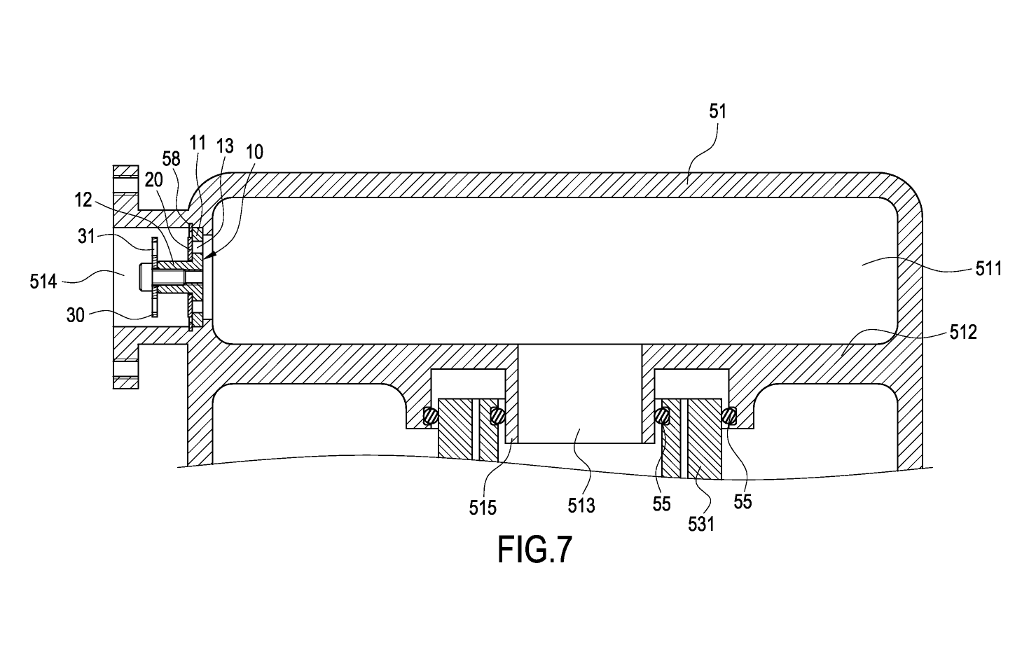

FIG. 7 is a sectional view of still another preferred embodiment of the present invention. The single-way valve is arranged laterally in the gas outlet 514 of the discharge passageway 511. Therefore, the single-way valve can be adapted for scroll compressor 5 of different sizes and applications.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A single-way valve for scroll compressor, the scroll compressor having a discharge passageway and the single-way valve arranged at one side of the discharge passageway, the single-way valve comprising:
a stage comprising a panel and a guiding post connected to the panel, a plurality of apertures defined on the panel;
a valve disc comprising a through hole capped on the guiding post such that the valve disc has linear movement along the guiding post; and
a baffle plate fixed on the guiding post to limit a moving stroke of the valve disc and comprising gas runner, wherein a contact area between the baffle plate and the valve disc is below 70% area of the valve disc.

2. The single-way valve for scroll compressor as in claim 1, wherein the single-way valve is arranged at a gas inlet of the discharge passageway.

3. The single-way valve for scroll compressor as in claim 1, wherein the single-way valve is arranged at a gas outlet of the discharge passageway.

4. The single-way valve for scroll compressor as in claim 1, wherein the panel is of round stair shape and the guiding post is extended upward from center of the panel.

5. The single-way valve for scroll compressor as in claim 1, wherein the apertures are in annulus arrangement at peripheral of the guiding post.

6. The single-way valve for scroll compressor as in claim 1, wherein the baffle plate is of round shape and the gas runners are a plurality of round through holes around the baffle plate in annulus arrangement.

7. The single-way valve for scroll compressor as in claim 1, wherein the baffle plate is of round shape and the gas runners are a plurality of fan-shaped grooves around the baffle plate.

8. The single-way valve for scroll compressor as in claim 1, wherein the baffle plate is of cross shape and each gas runner is formed between two adjacent branches of the baffle plate.
